(19) United States
(12) Patent Application Publication
(10) Pub. No.: US 2009/0292388 A1
(43) Pub. Date: Nov. 26, 2009

(54) SEMICONDUCTOR MANUFACTURING SYSTEM

(76) Inventor: Tatsushi Iimori, Tokyo (JP)

Correspondence Address: JORDAN AND HAMBURG LLP, 122 EAST 42ND STREET, SUITE 4000, NEW YORK, NY, 10168, US

(21) Appl. No.: 12/448,299

(22) PCT Filed: Dec. 19, 2006
(86) PCT No.: PCT/JP2006/325244

§ 371 Date: Jul. 20, 2009

(51) Int. Cl. G06F 19/00

(52) U.S. Cl. 700/112; 700/121

(57) ABSTRACT

An object of the present invention is to provide a semiconductor manufacturing system used for manufacturing a semiconductor in a semiconductor manufacturing facility according to a flow shop scheme. The semiconductor manufacturing system is provided with a plurality of bays having a plurality of pieces of semiconductor manufacturing equipment and intra-bay conveyance devices; an inter-bay conveyance device for conveying a carrier between the bays; and a flow shop controller, wherein each piece of semiconductor manufacturing equipment has one or more modules comprising a subsystem provided with at least one or more I/O devices; the bays, the semiconductor manufacturing equipment, the modules, the subsystems, and the I/O devices are each provided with a controller; each of the controllers is provided with a controller framework for implementing each function in accordance with a shared control scheme.

### BACKGROUND OF THE INVENTION

The present invention relates to a semiconductor manufacturing system used for manufacturing a semiconductor in a semiconductor manufacturing facility according to a flow shop scheme.

A semiconductor is manufactured by being subjected to a variety of processing steps in the clean room of a semiconductor manufacturing facility. The required number of semiconductor manufacturing equipment for executing each process according to a job shop scheme is provided in each processing step in the clean room. In other words, in a conventional semiconductor manufacturing facility, semiconductors are manufactured by a process in which a plurality of units referred to as bays is provided, and the semiconductors are conveyed between bays by a transfer robot or a belt conveyor. The semiconductor manufacturing equipment required for executing each step are arranged in each of the bays according to a job shop scheme.

However, in this job shop scheme, it is known that standby times, conveyance times within bays and between bays, and other wait times are long when a plurality of similar processing steps is repeated, and productivity is reduced. It has therefore been proposed to use semiconductor manufacturing lines that employ a flow shop scheme in which the semiconductor manufacturing equipment is provided in the sequence of processing steps, instead of employing the conventional job shop scheme.

However, productivity is not necessarily always improved when a semiconductor manufacturing line operating according to the flow shop scheme is provided to the semiconductor manufacturing facility. This is due to the fact that the operating capacity of each piece of semiconductor manufacturing equipment used in the semiconductor manufacturing line is not high on average. Therefore, suitable management and scheduling must be carried out in the semiconductor manufacturing equipment, bays, or the like in order to manufacture semiconductors with higher productivity. Patent Documents 1 through 3 below have therefore been disclosed.

Patent Document 1: Japanese Laid-open Patent Application No. 2004-349644

Patent Document 2: Japanese Laid-open Patent Application No. 2005-197500

Patent Document 3: Japanese Laid-open Patent Application No. 2001-143979

### SUMMARY OF THE INVENTION

The use of each of the above inventions allows the semiconductor manufacturing equipment, bays, and the like to be monitored to improve the operation of the factory but do not allow processes to be performed in order to improve the reliability of the semiconductor manufacturing equipment as such. This is due to the fact that current semiconductor manufacturing equipment is primarily manufactured by equipment manufacturers, the equipment is regarded as black boxes, and the detailed data from the semiconductor manufacturing equipment, i.e., the data related to making improvements in the reliability of the semiconductor manufacturing equipment as such, cannot be outputted. Even if data could be outputted, a mechanism is not provided for transmitting the data to a higher hierarchical level across the entire semiconductor manufacturing facility.

In other words, there is a need to perform scheduling or the like so as to improve productivity with consideration both for the operating capacity of the semiconductor manufacturing equipment and for the operation of the entire factory in order to improve the productivity of the semiconductor manufacturing line according to the flow shop scheme, but such improvement is not yet possible.

In view of the foregoing drawbacks, the inventors invented a semiconductor manufacturing system that improves productivity with consideration both for the operation of the factory and for the operating capacity of the semiconductor manufacturing equipment so as to improve the productivity of a semiconductor manufacturing line that employs a flow shop scheme.

According to a first aspect of the present invention, there is provided a semiconductor manufacturing system operating in accordance with a flow shop scheme, the semiconductor manufacturing system comprising: a plurality of bays provided with a plurality of pieces of semiconductor manufacturing equipment and an intra-bay conveyance device for conveying a carrier between the semiconductor manufacturing equipment; an inter-bay conveyance device for conveying a carrier between the bays; and a flow shop controller, wherein each piece of semiconductor manufacturing equipment has one or more modules comprising a subsystem provided with at least one or more I/O device; each of the bays has a bay controller, each piece of semiconductor manufacturing equipment has an equipment controller, each of the modules has a module controller, each of the subsystems has a subsystem controller, and each of the I/O devices has an I/O controller; and the flow shop controller, bay controller, equipment controller, module controller, subsystem controller, and I/O controller have a controller framework for implementing each function in accordance with a shared control scheme.

In accordance with the present invention, a controller framework that shares a control scheme with each hierarchical control level is provided to each hierarchical control level of the shop controller and therebelow, whereby the controller of each hierarchical control level can be shared in the entire semiconductor manufacturing system.

According to a second aspect of the present invention, there is provided a semiconductor manufacturing system in which the controller framework of each hierarchical control level is provided with at least a communication function program and a time adjustment function program, wherein the communication function program controls communication with a controller framework of a higher hierarchical control level and/or a lower hierarchical control level, and the time adjustment function program performs time control for setting the same time or substantially the same time in each controller framework.

In this manner, the controller framework is provided with a communication function program and a time adjustment function program, whereby required data can be communicated in the same format in each hierarchical control level, and the time in the controller of each hierarchical control level can be made the same or substantially the same.

According to a third aspect of the present invention, there is provided a semiconductor manufacturing system in which the controller framework provided to the equipment controller further has an EES function program, wherein the EES function program acquires software and hardware event data, as well as analog data and alert data, from the semiconductor manufacturing equipment, and uses the data as detailed equipment data by linking [the data] to a predetermined index; and the detailed equipment data is transmitted to the controller framework of a higher hierarchical control level via the communication function program.

According to a fourth aspect of the present invention, there is provided a semiconductor manufacturing system in which each controller framework provided with the bay controller and the flow shop controller further has an EES function program, wherein the EES function program transmits the detailed equipment data received from the lower hierarchical control level via the communication function program to the controller framework of a higher hierarchical control level via the communication function program.

With conventional semiconductor manufacturing equipment, it is not possible to acquire detailed equipment data such as that described above. Also, even if detailed equipment data could be acquired, the data is used only in the semiconductor manufacturing equipment and could not be handed off to a higher hierarchical control level. However, with the configuration of the present invention, detailed equipment data can be transmitted to a higher hierarchical control level, and each controller framework in each hierarchical control level can be shared. Therefore, detailed equipment data can be processed in a shared platform.

According to a fifth aspect of the present invention, there is provided a semiconductor manufacturing system operating in accordance with a flow shop scheme, the semiconductor manufacturing system comprising: a plurality of bays provided with a plurality of pieces of semiconductor manufacturing equipment and an intra-bay conveyance device for conveying a carrier between the semiconductor manufacturing equipment; an inter-bay conveyance device for conveying a carrier between the bays; and a flow shop controller, wherein each of the bays has a bay controller, and each piece of semiconductor manufacturing equipment has an equipment controller; the flow shop controller, the bay controller, and the equipment controller have a controller framework for implementing each function in accordance with a shared control scheme; each controller framework have at least a communication function program and a scheduler function program; the flow shop controller delivers a control instruction via the communication function program to the bays and the inter-bay conveyance device on the basis of scheduling for the bays and inter-bay conveyance in the scheduler function program; the bay controller delivers a control instruction via the communication function program to the semiconductor manufacturing equipment and the intra-bay conveyance device on the basis of scheduling for the semiconductor manufacturing equipment and the intra-bay conveyance in the scheduler function program; the equipment controller delivers a control instruction via the communication function program to the module and the inter-module conveyance device on the basis of scheduling for the module and the inter-module conveyance in the scheduler function program; and the number of installed equipment and the number of flow steps for each piece of semiconductor manufacturing equipment are computed on the basis of the operating capacity of lithography equipment as one of the pieces of semiconductor manufacturing equipment, and the scheduling is set on the basis of the computed number of installed equipment and the computed number of flow steps.

In accordance with the present invention, a controller framework for sharing a control scheme in each hierarchical control level is provided, whereby the controller of each control hierarch can be shared in the entire semiconductor manufacturing system. Control of the factory system and the semiconductor manufacturing system can thereby be shared. Also, the scheduler function program in the shared controller framework can perform control based on scheduling in each hierarchical control level.

In other words, the turn-around time (TAT) is determined by the turn-around time in equipment and the conveyance time to the semiconductor manufacturing equipment that will perform the next step. Since the turn-around time in semiconductor manufacturing equipment depends on the specifications of the semiconductor manufacturing equipment, the turn-around time will not be reduced unless the semiconductor manufacturing equipment is improved, but the conveyance time can still be improved. However, in a conventional configuration, a semiconductor is conveyed in an event-type processing structure based on a request from semiconductor manufacturing equipment, and conveyance in the conveyance devices is therefore started by a loading or unloading request that acts as a trigger from the semiconductor manufacturing equipment. However, scheduling in accordance with the scheduler function program of the present invention makes it possible to implement a shorter TAT than conventional event-type scheduling. In such scheduling, the number of equipment, flow steps, and the like is calculated with reference to lithographic equipment, making it possible to achieve maximal use of high-cost, high-throughput lithographic equipment.

According to a sixth aspect of the present invention, there is provided a semiconductor manufacturing system in which each controller framework in the flow shop controller, the bay controller, and the equipment controller receives, via each communication function program, one or more types of information selected from the group that includes malfunction information, recovery information, and remaining turn-around time information from any one or more of the pieces of semiconductor manufacturing equipment, the intra-bay conveyance devices, the bays, and the inter-bay conveyance device; the scheduler function program in the flow shop controller performs rescheduling at a timing at which an entrance of the flow shop is accessed; and the scheduler function program in the bay controller performs rescheduling at a timing at which an entrance of the bays is accessed.

Once scheduling has been performed, the scheduler function programs thereafter perform rescheduling at predetermined timing. Various types of information can thereby be received in real time, and semiconductor manufacturing equipment malfunctions and the like can be flexibly handled.

According to a seventh aspect of the present invention, there is provided a semiconductor manufacturing system in which each controller framework further has an EES function program, wherein the EES function program in the equipment controller acquires software and hardware event data, as well as analog data and alert data, from the semiconductor manufacturing equipment, and uses the data as detailed equipment data by linking [the data] to a predetermined index; the detailed equipment data is transmitted to the controller framework of a higher hierarchical level via the communication function program; the detailed equipment data is transmitted to the controller framework of a higher hierarchical level via the communication function program; the EES function program in the bay controller and the flow shop controller transmits the detailed equipment data received from the lower hierarchical level via the communication function program; and the scheduler function program in each controller framework performs scheduling or rescheduling on the basis of the detailed equipment data.

In the case the scheduling and rescheduling are to be carried out, the scheduling and rescheduling may be performed on the basis of detailed equipment data acquired by the EES function program. Since the data of the semiconductor manufacturing equipment is included in the detailed equipment data, scheduling and rescheduling may be carried out using the detailed equipment data, and a shorter TAT can be achieved.

In accordance with the aspects described above, control of the semiconductor manufacturing system in the wiring step can be shared by providing a controller framework to the controllers of each hierarchical control level in the semiconductor manufacturing system. In the case that a controller framework is also provided to the MES, it is possible to share control in the MES, which is the highest level of the factory system, and in the semiconductor manufacturing system operating in accordance with a flow shop scheme. Accordingly, it is possible to obtain shared control in factory units and to receive data from the semiconductor manufacturing equipment and the like. Therefore, the operating capacities and the like of the semiconductor manufacturing equipment can be managed using a flow shop controller and an MES, and it is possible to produce a production plan in accordance with the operating capacities. The result is an improvement in productivity.

A program for implementing the EES function is plugged into the controller framework, whereby a mechanism is constructed in which the detailed equipment data for improving equipment reliability in the controller framework of each hierarchical level is readily passed on to the factory system, leading to an improvement in productivity with consideration given to the operating capacity of the factory and the semiconductor manufacturing equipment.

Furthermore, scheduling and rescheduling are carried out by the scheduler function program in each controller framework of the flow shop controller, the bay controller, and the equipment controller on the basis of the detailed equipment data acquired by the EES function program in the controller framework. Productivity can therefore be further improved and a shorter TAT can be achieved.

### BRIEF DESCRIPTION OF THE DRAWINGS

FIG. 1 is a schematic view showing an example of the semiconductor manufacturing system;

FIG. 2 is a schematic view showing another example of the semiconductor manufacturing system;

FIG. 3 is a schematic view showing another example of the semiconductor manufacturing system;

FIG. 4 is a schematic view showing an example of the semiconductor manufacturing equipment;

FIG. 5 is a schematic view showing an example of the modules;

FIG. 6 is a diagram showing the hierarchical control level in the semiconductor manufacturing system;

FIG. 7 is a schematic view showing the controller framework;

FIG. 8 is a schematic view showing the organizational relationship of the controller framework;

FIG. 9 is a schematic view showing the organizational relationship of the communication function program;

FIG. 10 is a schematic view showing the organizational relationship of the EES function program;

FIG. 11 is a schematic view showing the throughput for each piece of semiconductor manufacturing equipment;

FIG. 12 is a schematic view showing the semiconductor manufacturing equipment in the sequence of processing steps;

FIG. 13 is a schematic view showing a case in which the estimated operating capacity for each piece of semiconductor manufacturing equipment is set;

FIG. 14 is a schematic view showing a case in which the ratio of the number of processed wafers for each piece of semiconductor manufacturing equipment is set;

FIG. 15 is a schematic view showing a case in which the apparent throughput for each piece of semiconductor manufacturing equipment is computed;

FIG. 16 is a schematic view showing a case in which the necessary number of installed pieces of semiconductor manufacturing equipment in the sequence of processing steps is computed;

FIG. 17 is a schematic view showing the manner in which the conveyance time is concealed when the semiconductor manufacturing equipment each have the same throughput;

FIG. 18 is a schematic view showing the manner in which the conveyance time is concealed when the semiconductor manufacturing equipment each have different throughputs;

FIG. 19 is a schematic view showing the elimination of waiting at the load port when the turn-around time differs according to the recipe of the semiconductor manufacturing equipment; and

FIG. 20 is a schematic view showing the elimination of waiting at the load port when the turn-around time increases due to malfunctioning of semiconductor manufacturing equipment.

### DETAILED DESCRIPTION OF THE INVENTION

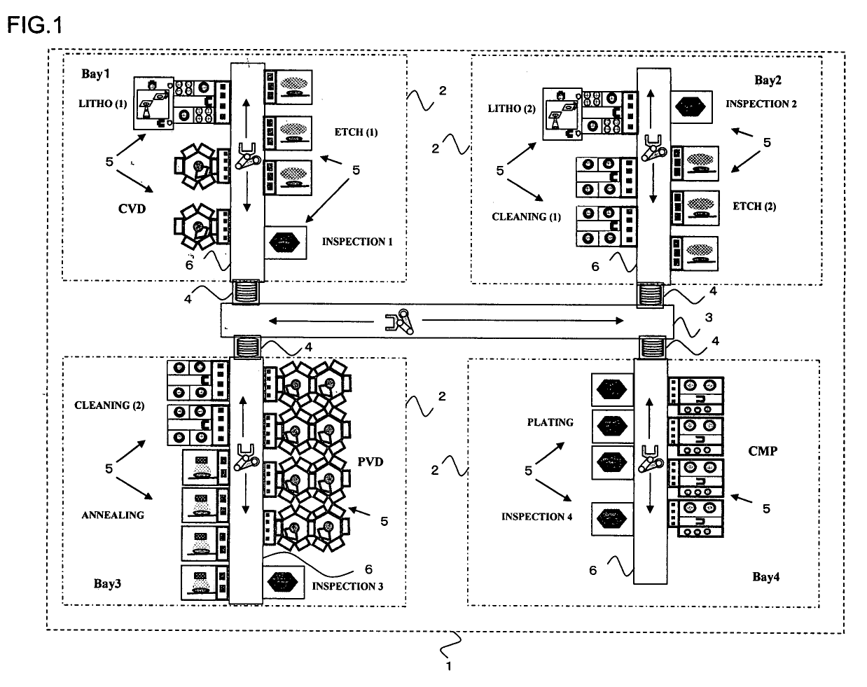

The steps for manufacturing a semiconductor in a semiconductor manufacturing facility are broadly classified into wiring steps and transistor formation steps. The semiconductor manufacturing system 1 of the present invention is suitable for use in the wiring steps. An example of the semiconductor manufacturing system 1 (hereinafter referred to as semiconductor manufacturing system 1) of the wiring steps is shown in FIG. 1.

A MES 20 (Manufacturing Execution System) (not shown) for controlling the overall semiconductor manufacturing facility controls the wiring step as well as the transistor formation step. In the wiring step, a lower hierarchical control level of the MES 20 in the semiconductor manufacturing system 1 has a plurality of bays 2, and an inter-bay conveyance device 3 for conveyance between the bays. The bays 2 also have one or more pieces of semiconductor manufacturing equipment 5 for performing the processing of each step in the wiring steps of semiconductor manufacturing, and an intra-bay conveyance device 6 for conveyance between the semiconductor manufacturing equipment in the bays. Each piece of semiconductor manufacturing equipment 5 has one or more modules 7, and an inter-module conveyance device 8 for conveyance between the modules 7 in the semiconductor manufacturing equipment. Each of the modules 7 has one or more subsystems 9. In addition, the subsystems 9 have one or more I/O device 10.

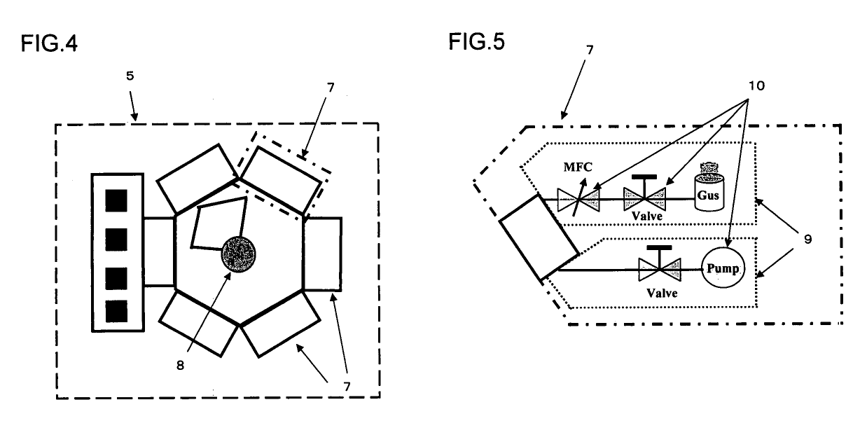

FIG. 4 shows an example of the semiconductor manufacturing equipment 5. FIG. 5 shows an example of the modules 7.

In the semiconductor manufacturing system 1 shown in FIG. 1, inter-bay buffers 4 are provided for conveyance between bays. The inter-bay buffers 4 are equipment for maintaining a temporary standby state until the inter-bay conveyance device 3 arrives to convey the carrier to another bay 2 and starts to load the carrier after processing in a bay 2 is completed.

As described above, the bays 2 are provided with semiconductor manufacturing equipment 5 and an intra-bay conveyance device 6, but various types of equipment can be used as the semiconductor manufacturing equipment 5. Examples thereof include lithography equipment (labeled “litho” in FIG. 1), etching equipment (“etch” in FIG. 1), CVD (Chemical Vapor Deposition) equipment (“CVD” in FIG. 1), inspection equipment (“inspection” in FIG. 1), cleaning equipment (“cleaning” in FIG. 1), annealing equipment (“annealing” in FIG. 1), PVD (Physical Vapor Deposition) equipment (“PVD” in FIG. 1), plating equipment (“plating” in FIG. 1), CMP (Chemical Mechanical Polishing) equipment (“CMP” in FIG. 1), and other equipment, but other appropriate semiconductor manufacturing equipment 5 can also be used. The semiconductor manufacturing equipment 5 may be composed of a plurality of modules 7, as shown in FIGS. 4 and 5. The modules 7 may be furthermore composed of a plurality of subsystems 9, and the subsystems 9 may be further composed of a plurality of I/O devices 10, e.g., MFC, valves, and pumps.

Each piece of semiconductor manufacturing equipment 5 is provided with at least one load port for loading and unloading a carrier to and from the intra-bay conveyance devices 6. The intra-bay conveyance devices 6 are provided with a mechanism capable of continuously loading and unloading carriers through the inter-bay buffers 4 and the load ports of the semiconductor manufacturing equipment 5. For example, a mechanism may be provided in which the intra-bay conveyance devices 6 have two arms, a carrier for which processing is completed is unloaded (retrieved) from the semiconductor manufacturing equipment 5 by one arm, and a carrier that has been conveyed is loaded (transferred) by the other arm. Alternatively, such mechanisms may be provided as one in which two stages are provided to the intra-bay conveyance devices 6, and a processed carrier unloaded from semiconductor manufacturing equipment 5 is placed on one stage that is empty, after which the carrier is loaded into the semiconductor manufacturing equipment 5 from a stage onto which a carrier for loading was placed.

The inter-bay conveyance device 3 and the inter-module conveyance device 8 are also preferably provided with a mechanism for continuously loading and unloading carriers in the same manner as in the intra-bay conveyance devices 6.

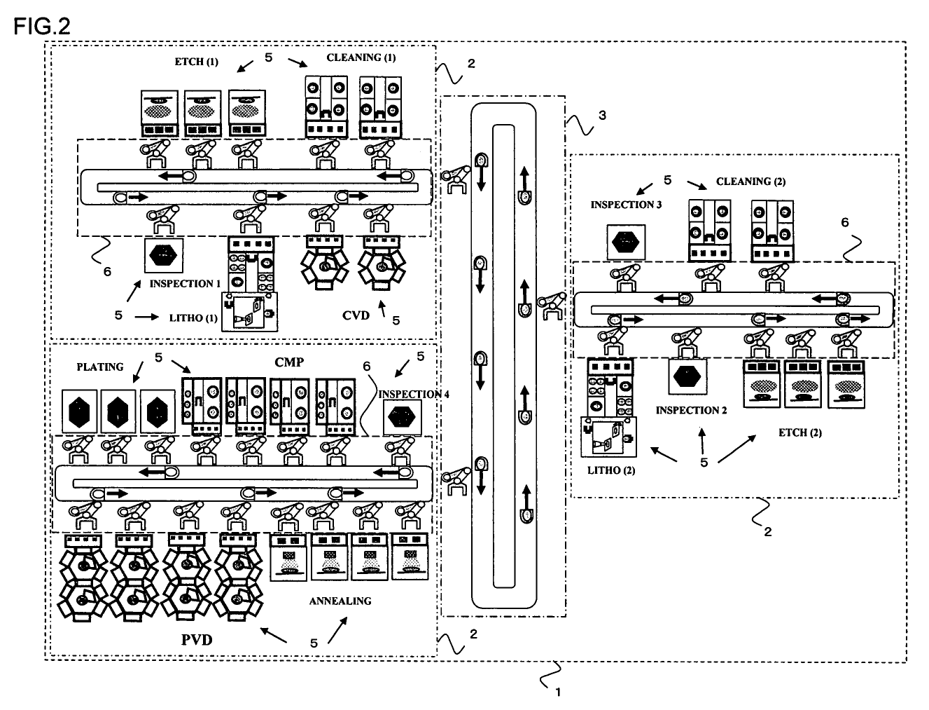

A case is described herein in which a transfer robot is used as the inter-bay conveyance device 3 for conveying between bays in the semiconductor manufacturing system 1 shown in FIG. 1, but the inter-bay conveyance device 3 may also be a conveyance device on a belt conveyor, as shown in FIG. 2. In this case, since the belt conveyor as such performs the same function as the inter-bay buffers 4, there is no need for the inter-bay buffers 4. Conveyance between bays may also be configured so that carriers for which processing has been completed stand by at the inter-bay buffers 4, and the intra-bay conveyance devices 6 then load carriers for which processing is to be performed from the inter-bay buffers 4, whereby inter-bay conveyance is essentially performed.

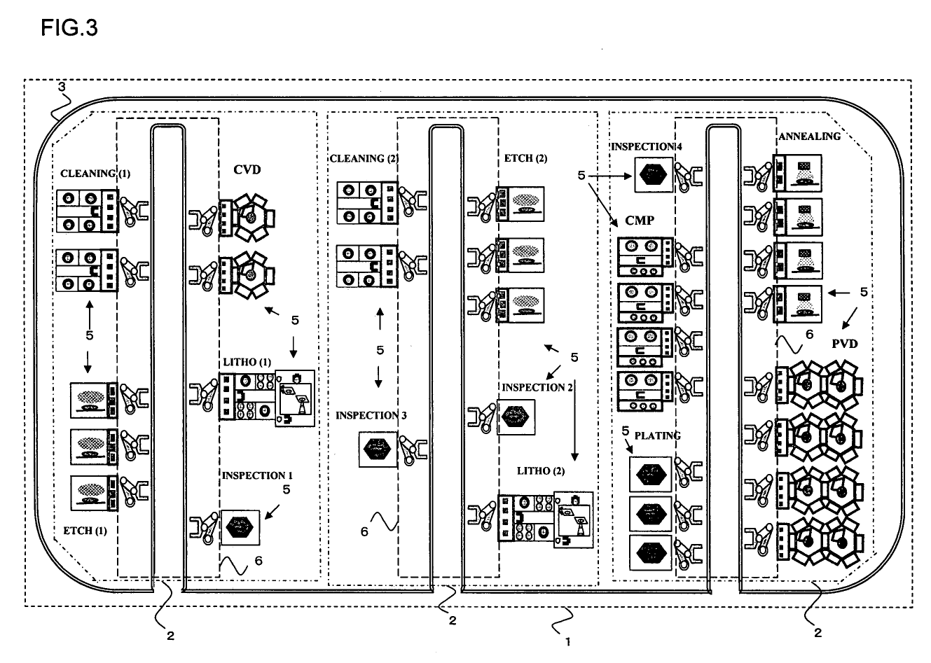

The inter-bay conveyance device 3 and the intra-bay conveyance devices 6 may be disposed on a single belt conveyor, as shown in FIG. 3.

For convenience in the present specification, the case of the semiconductor manufacturing system 1 shown in FIG. 1 will be described, but processing can be performed in the same manner by the semiconductor manufacturing systems 1 shown in FIGS. 2 and 3, or by another semiconductor manufacturing system 1.

In the wiring step in semiconductor manufacture, a computer system referred to as a flow shop controller 21 for controlling the entire flow shop and controlling the bays 2 and the inter-bay conveyance device 3 is provided as a lower hierarchical control level of the MES 20. The bays 2 are provided with a computer system referred to as a bay controller 23 for controlling the bays overall on the basis of instructions from the flow shop controller 21 and for controlling the semiconductor manufacturing equipment 5 and the intra-bay conveyance devices 6 in the bays. The semiconductor manufacturing equipment 5 is provided with a computer system referred to as an equipment controller 25 for controlling the semiconductor equipment on the basis of instructions from the bay controller 23 and for controlling the inter-module conveyance device 8 and the modules 7 constituting the semiconductor manufacturing equipment 5. The modules 7 are provided with a computer system referred to as a module controller 27 for controlling the modules as such on the basis of instructions from the equipment controller 25 and for controlling the subsystems 9 constituting the modules 7. The subsystems 9 are provided with a computer system referred to as a subsystem controller 28 for controlling the subsystems as such on the basis of instructions from the module controller 27 and for controlling the I/O devices 10 constituting the subsystems 9. The I/O devices 10 are provided with a computer system referred to as an I/O controller 29 for controlling the I/O devices as such on the basis of instructions from the subsystem controller 28.

The inter-bay conveyance device 3, the intra-bay conveyance devices 6, and the inter-module conveyance device 8 are provided with and are controlled by computer systems referred to as an inter-bay conveyance controller 22, an intra-bay conveyance controller 24, and an inter-module conveyance controller 26, respectively. The inter-bay conveyance controller 22, the intra-bay conveyance controller 24, and the inter-module conveyance controller 26 control the equipment on the basis of instructions from the flow shop controller 21, the bay controller 23, and the equipment controller 25, respectively.

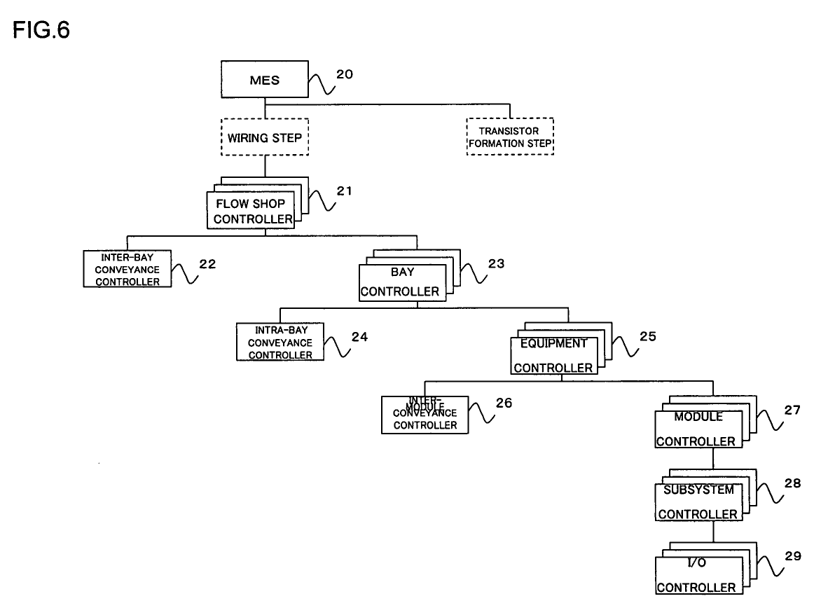

FIG. 6 is a hierarchical control level diagram of the MES 20, the flow shop controller 21, the bay controller 23, the inter-bay conveyance controller 22, the equipment controller 25, the intra-bay conveyance controller 24, the module controller 27, the inter-module conveyance controller 26, the subsystem controller 28, and the I/O controller 29.

The controllers are provided with a control program, which is a so-called embedded OS and is referred to as a controller framework. As described above, not only are the controllers provided with a controller framework, but the MES 20 may also be provided with a controller framework. In this case, the control scheme of an entire factory can be shared. The controller framework provided to the MES 20 is preferably configured so as to function within the OS (or embedded OS) originally provided to the MES 20. It is also apparent that the controller framework may be provided solely to the hierarchical control levels of the flow shop controller 21 and therebelow without providing the controller framework to the MES 20. In this case, the control scheme can be shared in at least the wiring step.

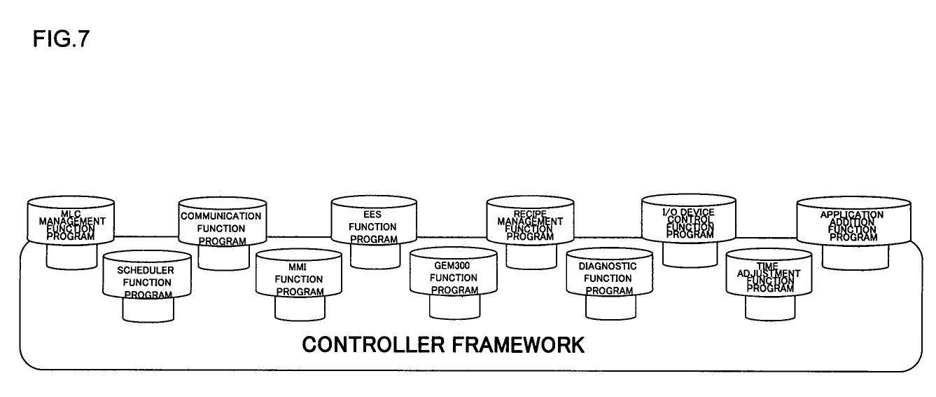

The controller framework is a control program having a framework structure that can accept a plurality of function programs as plug-ins, and is a program for sharing a control scheme in the controller of each hierarchical level. Examples of such programs include an MLC management function program, a scheduler function program, a communication function program, an EES function program, a time adjustment function program, a recipe management function program, a diagnostic function program, an I/O device control function program, an MMI function program, and a GEM300 function program. FIG. 7 shows a conceptual view of a controller framework.

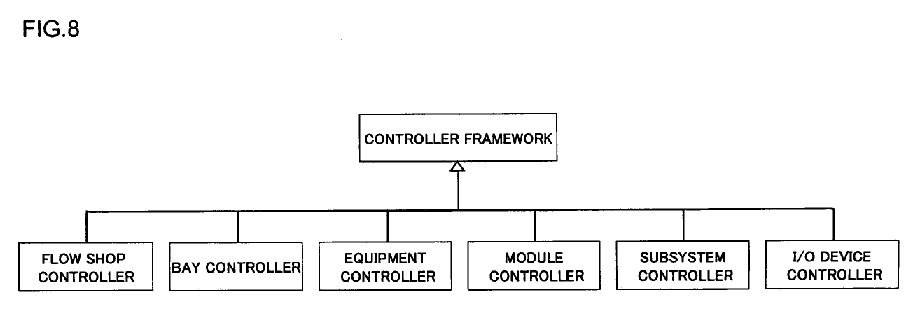

The controller framework is provided to the controllers of each hierarchical level, but it is preferred that required function programs be suitably added to the controller framework, and functional programs that are not required be suitably eliminated from the controller framework. Since a controller framework is provided to each hierarch, each controller is in an organizational relationship to the controller framework. This is shown in FIG. 8.

The MLC management function program is provided to the controllers of each hierarchical level and is a program for managing the controllers of each hierarchical level.

The scheduler function program is a function program for implementing optimal conveyance and is provided to controllers other than the module controller 27, the subsystem controller 28, and the I/O controller 29, that is, to controllers of the hierarchical levels to which the conveyance device is connected, i.e., the equipment controller 25, the bay controller 23, and the flow shop controller 21.

The scheduler function program in the controller framework of the flow shop controller 21, the bay controller 23, and the equipment controller 25 is a so-called scheduler, and schedule inter-bay conveyance, loading and unloading to and from the semiconductor manufacturing equipment 5 in the bays, intra-bay conveyance, loading and unloading to and from the modules 7 in the semiconductor manufacturing equipment, and inter-module conveyance on the basis of a pre-set schedule. The use of such a scheduler makes it possible to conceal the conveyance time between the modules 7, the semiconductor manufacturing equipment 5, and the bays, i.e., to achieve a reduction in standby time. Scheduling that is once set is rescheduled at a pre-set timing. In the case of the flow shop controller 21, rescheduling is performed at the timing at which the inter-bay conveyance device 3 accesses the entrance of the flow shop. In the case of the bay controller 23, rescheduling is performed at the timing at which the intra-bay conveyance device 6 accesses the entrance of the bays 2. In the case of the equipment controller 25, rescheduling is performed at the timing at which the inter-module conveyance device 8 accesses the entrance of the semiconductor manufacturing equipment 5.

Scheduling in the scheduler function program will be described at a later point.

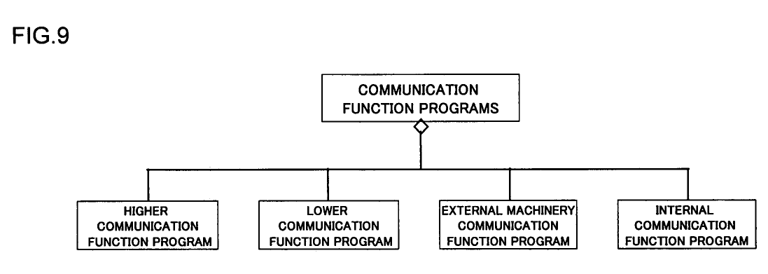

The communication function program is provided to the controller framework of each hierarchical level, and is a function program for implementing a function for communication between higher hierarchical level controllers and lower hierarchical level controllers, communication between processes inside a controller, and communication with external measurement equipment or the like connected to the equipment or the like provided with the controllers. The communication function program is composed of a plurality of function programs, e.g., a higher communication function program, a lower communication function program, an external equipment communication function program, and an internal communication function program, as shown in FIG. 9. The higher communication function program is a function program for controlling communication with the controllers of higher hierarchical levels, and the lower communication function program is a function program for controlling communication with the controllers of lower hierarchical levels. The external communication function program is a function program for controlling communication with external measurement equipment and other external equipment, and the internal communication function program is a function program for controlling communication between processes.

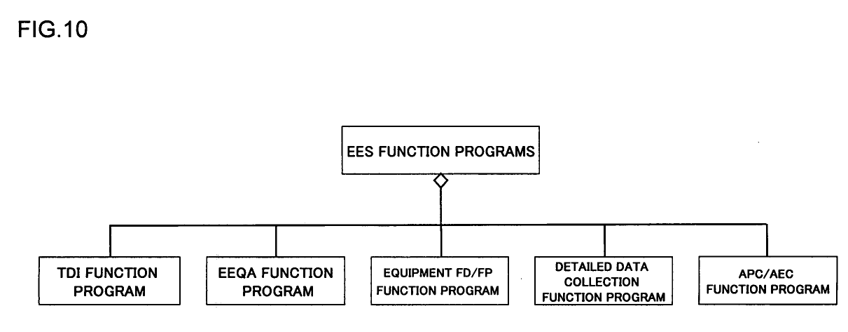

The EES function program is provided to the flow shop controller 21, the bay controller 23, and the equipment controller 25, and is a function program for improving the reliability of the semiconductor manufacturing equipment 5 and the conveyance devices. The EES function program is composed of a plurality of function programs, as shown in FIG. 10, including a TDI function program, an EEQA function program, an equipment FD/FP function program, a detailed data collection function program, and an APC/AEC function program. The TDI function program is a function program that provides functions defined by Selete, an industry organization. The EEQA function program is a program for performing quality assurance, determining whether the detailed equipment data received from the semiconductor manufacturing equipment 5 is within upper and lower limit values, and assuring the determination. The equipment FD/FP function program is program for detecting and predicting errors in the semiconductor manufacturing equipment 5, the bays 2, and the like. This function program determines upward and downward trends and performs other statistical analyses on the detailed equipment data received from the semiconductor manufacturing equipment 5, and predicts errors by determining whether an error can occur.

The detailed data collection program acquires detailed equipment data from the semiconductor manufacturing equipment 5 in the case that a controller framework provided with an EES function program is provided to the equipment controller 25 of the semiconductor manufacturing equipment 5, and is a function program for transmitting the detailed equipment data via the communication function program to the bay controller 23, which is a higher hierarchical level. In the case that a controller framework provided with an EES function program is provided to the bay controller 23 of the bays 2, the flow shop controller 21, the MES 20, and the like, which are higher hierarchical levels of the semiconductor manufacturing equipment 5, the detailed equipment data is received from a lower hierarchical level via the communication function program and is transmitted to a higher hierarchical level via the communication function program. In this case, detailed equipment data includes software and hardware event data, analog data, and alarm (warning) data. The event data, analog data, and alarm data are handled as detailed equipment data that is linked to an index, e.g., information that shows the time at which a process has been carried out, as well as which bays 2, semiconductor manufacturing equipment 5, modules 7, and I/O devices 10 the process has been performed in, and which process has been carried out.

Even if such detailed equipment data is controlled by the semiconductor manufacturing equipment as such, the prior art fails to provide a structure in which the detailed equipment data is transmitted to a controller of a higher hierarchical level. [With the present invention,] however, this is made possible by using a detailed data collection function program or a communication function program in the EES function program. It is even more preferred that the an EEQA function program also be used in the EES function program because the detailed equipment data can be assured in terms of quality to be within upper and lower limit values.

The APC/AEC function program is a function program for implementing functions related to APC (Advanced Process Control) and AEC (Advanced Equipment Control).

The time adjustment function program is provided to the controller framework of the controller of each hierarchical level and is a function program for adjusting the time among the controllers. The time adjustment function program makes adjustments so that the time in each controller is the same time, but this depends on whether the EES function program is provided. In other words, in order to implement an EES function, it is necessary to link various data as the detailed equipment data in the manner described above, and in order to carry out the linkage in an accurate manner, the linkage must be carried out based on the time in the detailed equipment data presented by the semiconductor manufacturing equipment 5. However, the linkage cannot be accurately carried out when the time is different for each piece of semiconductor manufacturing equipment. Therefore, in the case that the time adjustment function program of the controller framework is provided to the flow shop controller 21, the bay controller 23, the equipment controller 25, and the like, the time information (or date and time information) is acquired from a timeserver installed in the semiconductor manufacturing facility or in a predetermined location, and the time information (or date and time information) thus acquired is transmitted to a controller in a lower hierarchical level via the communication function program. The module controller 27, the subsystem controller 28, the I/O controller 29, and other controllers that cannot directly access the timeserver receive, via the communication function program, the time information (or date and time information) acquired from a controller of a higher hierarchical level that has accessed the timeserver. The time of the controllers in each hierarchical level is adjusted to the same time in this manner.

The recipe management function program is provided with a controller framework of each hierarchical level, excluding the I/O controller 29, and is a function program for managing the process recipes.

The diagnostic function program is provided to the controller framework of each hierarchical level and is a function program for performing a self-diagnostic of the communication state, computer resources such as the CPU and disk, the I/O operating state, and the like

The I/O device control function program is a function program for controlling motors, valves, or sensors and other I/O devices 10 such as those shown in FIG. 6. The I/O device control function program is ordinarily provided to the controller framework of the I/O controller 29, but may also be provided to each controller framework of the subsystems 9 or the modules 7 when the I/O devices 10 are connected to the subsystems or the modules.

The MMI function program is a function program for implementing a man-machine interface. The MMI function program is provided to the controller framework of the flow shop controller 21, the bay controller 23, and the equipment controller 25, but may also be provided to other hierarchical levels, and this function program may be provided when an interface is provided.

The GEM300 function program is provided to the controller framework of the flow shop controller 21, the bay controller 23, and the equipment controller 25, and is a function program provided with a SEMI specification defined for a 300-mm semiconductor manufacturing line.

With each controller of the higher hierarchical level and the lower hierarchical level, predetermined data communication can be carried out using the communication function program of the controller framework. For example, reports and the like are made of the conveyance instructions from the flow shop controller 21 to the inter-bay conveyance controller 22, conveyance responses from the inter-bay conveyance controller 22 to the flow shop controller 21, and position information of the transfer robot of the inter-bay conveyance device 3 from the inter-bay conveyance controller 22 to the flow shop controller 21. Additionally, reports and the like are made of conveyance instructions from the bay controller 23 to the intra-bay conveyance controller 24, conveyance responses from the intra-bay conveyance controller 24 to the bay controller 23, and position information of the transfer robot of the intra-bay conveyance devices 6 from the intra-bay conveyance controller 24 to the bay controller 23. Furthermore, reports and the like are made of conveyance instructions from the equipment controller 25 to the inter-module conveyance controller 26, conveyance responses from the inter-module conveyance controller 26 to the equipment controller 25, and position information of the transfer robot of the inter-module conveyance device 8 from the inter-module conveyance controller 26 to the equipment controller 25. The processing-state information, malfunction information, recovery information, remaining turn-around time information, and the like are communicated between the flow shop controller 21 and each bay controller 23, the bay controller 23 and the equipment controller 25, the equipment controller 25 and the module controller 27, the module controller 27 and the subsystem controller 28, and the subsystem controller 28 and the I/O controller 29.

A controller framework is provided to the controllers of each hierarchical level in the manner described above, and the function programs constituting the controller framework in each hierarchical level are executed. In particular, the EES function program acquires the detailed equipment data from the semiconductor manufacturing equipment 5 at predetermined timing in the equipment controller 25, and transmits the detailed equipment data to the bay controller 23 via the communication function program. When the EES function program in the controller framework of the bay controller 23 acquires the detailed equipment data via the communication function program, the detailed equipment data acquired from the semiconductor manufacturing equipment 5 in the bays 2 is furthermore transmitted to the flow shop controller 21 via the communication function program. In this situation, the EES function program of the bay controller 23 preferably adds time information, as well as information indicating that the data has been acquired by the bay controller 23, to the detailed equipment data acquired from the semiconductor manufacturing equipment 5, and transmits the data to the flow shop controller 21.

When the detailed equipment data is acquired from the bay controller 23 by the EES function program in the controller framework of the flow shop controller 21 via the communication function program, the detailed equipment data acquired from the bays 2 in the flow shop controller 21 is furthermore transmitted to the MES 20 via the communication function program. In this case, the EES function program of the flow shop controller 21 preferably adds time information, as well as information indicating that the data has been acquired by the flow shop controller 21, to the detailed equipment data acquired from the bays 2, and transmits the data to the MES 20.

Next, scheduling in the scheduler function program will be described.

Provided first is a description of the process flow for determining the installed number of semiconductor manufacturing equipment 5, the number of equipment handled by a single intra-bay conveyance device 6 (referred to as the “number of flow steps”), or the equipment layout. This data is necessary to perform scheduling by the scheduling function program of the flow shop controller 21 and the scheduling function program of the bay controller 23. This can be executed by any computer system, including the flow shop controller 21 and the bay controllers 23.

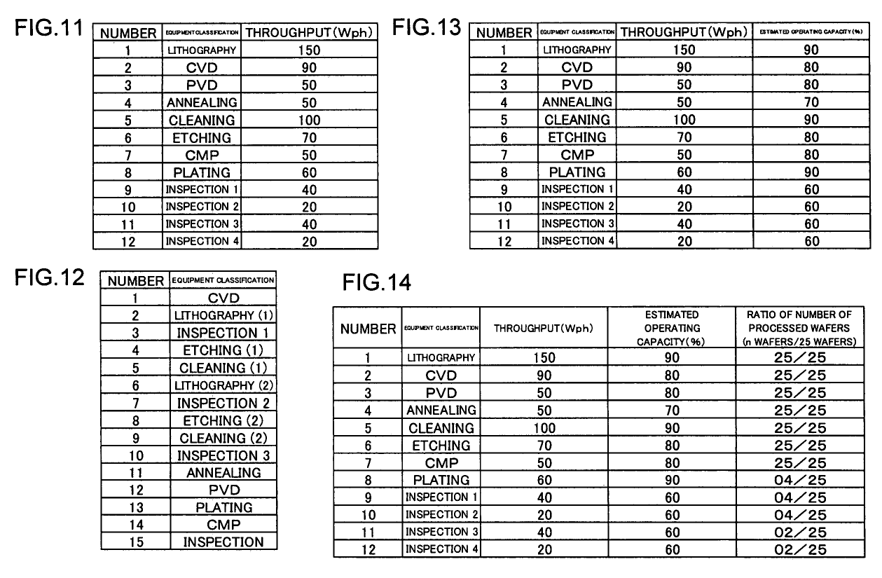

A case will be described in which the semiconductor manufacturing equipment 5 of the wiring steps executed in the semiconductor manufacturing system 1 of the present specification are lithography equipment, CVD equipment, PVD equipment, annealing equipment, cleaning equipment, etching equipment, CMP equipment, plating equipment, and inspection equipment (inspections 1 through 4) (FIG. 11). The process flow of the wiring steps is assumed to take place in the sequence shown in FIG. 12. In FIGS. 11 and 12, the numbers in parentheses after the semiconductor manufacturing equipment 5 indicate performance of the same processing step for the same type of processing; for example, lithography (1) and lithography (2) indicate a first instance of processing and a second instance of processing in the lithography equipment.

The process for determining the number of installed pieces of semiconductor manufacturing equipment 5 will first be described.

Among the semiconductor manufacturing equipment 5 in the semiconductor manufacturing system 1, the lithography equipment used in the lithography step is the most costly, and the throughput thereof is also higher than that of the other semiconductor manufacturing equipment 5. Therefore, based on financial efficiency, the operating capacity of the lithography equipment must be set as high as possible. In the usual wiring process, since there are two lithography steps as shown in FIG. 12, two pieces of lithography equipment are required.

The equipment operating capacities in the semiconductor manufacturing equipment 5 are then set. An example of the equipment operating capacities is shown in FIG. 13. These equipment operating capacities may be arbitrarily set based on past experience or the like, and the equipment operating capacities may also be set based on the detailed equipment data received from the EES function program of the controller framework of each hierarchical level. For example, the operating state and the stoppage state of each equipment is determined based on event data, analog data, alarm data, or the like of software or hardware in the detailed equipment data, and the equipment operating capacities can be calculated by computing the time of operating and stoppage states. It is possible to determine if the information for identifying the equipment is information about a particular piece of equipment on the basis of information for identifying the equipment linked to the event data, the analog data, and the alarm data in the detailed equipment data.

The ratio of the number of processed wafers, which indicates how many wafers from a loaded carrier are actually processed, is then set in the semiconductor manufacturing equipment 5. The reason for setting the ratio of the number of processed wafers is that even though all of the carriers are processed in the usual processing steps in the wiring step, not all of the carriers are inspected or otherwise processed in the inspection step and other steps. FIG. 14 shows a state in which this ratio is set. FIG. 14 shows a case in which the ratio of the number of processed wafers per 25 wafers is set. The reason for this is that one carrier is often composed of 25 wafers.

When the estimated operating capacity and the ratio of the number of processed wafers are set for each piece of semiconductor manufacturing equipment 5 in this manner, the apparent throughput per each piece of semiconductor manufacturing equipment 5 is computed using Equation 1 below.

Apparent throughput=Throughput×(Estimated operating capacity÷100)×(1÷Ratio of the number of processed wafers) (Eq. 1)

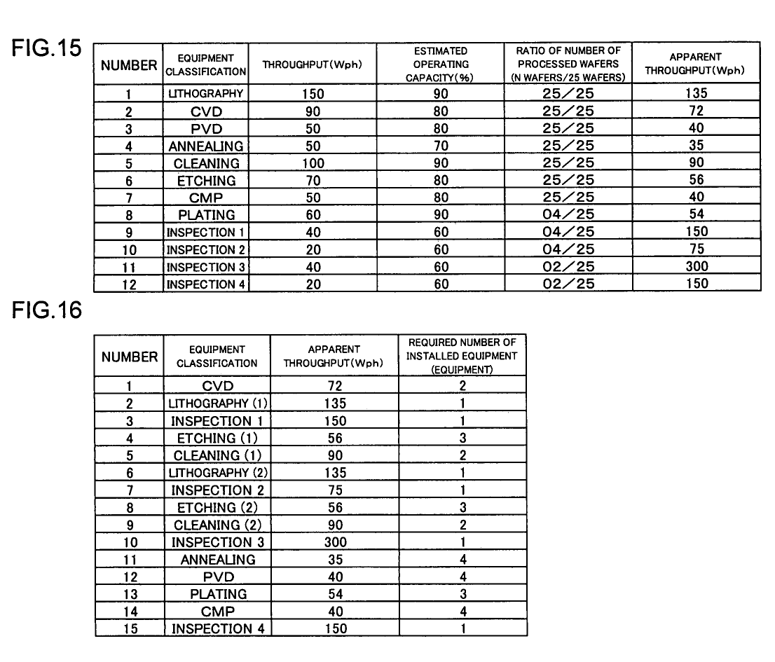

FIG. 15 shows a state in which the apparent throughput per each piece of semiconductor manufacturing equipment 5 is set.

When the apparent throughput of the semiconductor manufacturing equipment 5 is computed as described above, the required number of installed pieces of semiconductor manufacturing equipment 5 can be computed as the number of installed equipment that satisfies Equation 2.

Apparent throughput×Number of installed equipment≧Apparent throughput of the lithography equipment (Eq. 2)

FIG. 16 shows the required number of installed pieces of semiconductor manufacturing equipment 5 used in each processing step. The required number of installed pieces of semiconductor manufacturing equipment 5 can be computed by a process such as described above.

The process for determining the number of flow steps will next be described.

The maximum value of the conveyance time between equipment by the intra-bay conveyance devices 6 is first designated as t (t includes the carrier loading/unloading times with respect to the semiconductor manufacturing equipment 5). When the throughput of the semiconductor manufacturing equipment 5 is designated as P (Wph), the turn-around time per wafer is 3600/P (seconds). In the process for determining the required number of installed pieces of semiconductor manufacturing equipment 5 described above, since setting is performed so that the equipment types other than the lithography equipment have a greater throughput than the lithography equipment (according to Eq. 2), the semiconductor manufacturing equipment 5 having the smallest throughput is the lithography equipment.

A number of flow steps that satisfies Equation 3 is determined in order to conceal the conveyance time.

(t×Number of flow steps for conveyance)≧Turn-around time per wafer (Eq. 3)

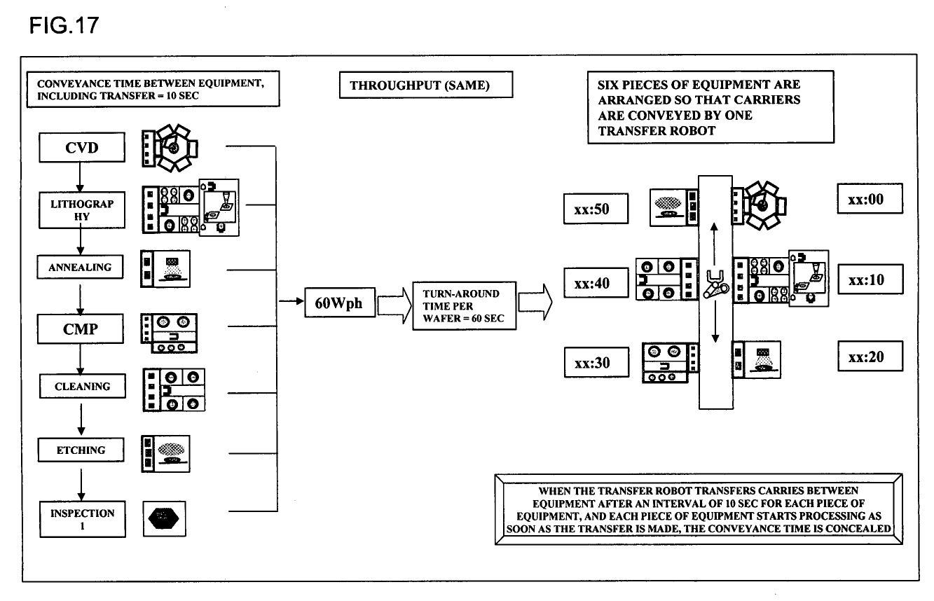

For example, when the inter-equipment conveyance time is 10 seconds, and the processing steps are executed in the sequence of CVD equipment, lithography equipment, annealing equipment, CMP equipment, cleaning equipment, etching equipment, and inspection equipment (inspection 1), the throughput is 60 Wph based on the throughput values in FIG. 15 and other diagrams. In other words, the turn-around time per wafer is 60 seconds. The number of flow steps is thus calculated as 6 by Eq. 3. In other words, in this set of processing steps, the equipment can be arranged so that conveyance for six pieces of semiconductor manufacturing equipment 5 is performed by one of the intra-bay conveyance devices 6. This arrangement is shown schematically in FIG. 17.

Since the number of pieces of semiconductor manufacturing equipment 5 for which conveyance is handled by one of the intra-bay conveyance devices 6 is necessarily determined when the number of flow steps is determined, the number of pieces of semiconductor manufacturing equipment 5 installed for each bay 2, i.e., the layout, is determined.

A method for concealing the conveyance time is set when the number of flow steps is determined in this manner. The timing at which the intra-bay conveyance device 6 unloads or loads carriers in sequence with respect to the semiconductor manufacturing equipment 5 on the basis of a pre-set schedule is first offset by the abovementioned time t, and the start of processing by the semiconductor manufacturing equipment 5 is also offset by the time t. Through this configuration, when a continuously processed carrier is present, the succeeding carrier can be transferred at the time that processing of the preceding carrier is completed, and the apparent conveyance time is substantially concealed by the elimination of the time needed for the first carrier to be transferred to each piece of semiconductor manufacturing equipment 5 and the conveyance time needed for the final carrier to be returned.

The information that forms the basis of scheduling is set as described above. Based on this set information, the scheduling is set by the scheduler function program in the controller framework of the flow shop controller 21 and the scheduler function program in the controller framework of the bay controller 23 so that the conveyance time is concealed. The controller framework of the flow shop controller 21 transmits instructions relating to control procedures of the bays 2, as well as instructions relating to control procedures of the inter-bay conveyance device 3, to each controller framework of the bay controller 23 and the inter-bay conveyance 22 controller on the basis of scheduler function program of the flow shop controller 21. Based on the instructions, the bay controller 23 controls the bays 2, and the inter-bay conveyance controller 22 controls the inter-bay conveyance device 3. The controller framework of the bay controller 23 transmits instructions relating to control procedures of the semiconductor manufacturing equipment 5 in the bays 2, as well as instructions relating to control procedures of the intra-bay conveyance devices 6, to the equipment controllers 25 and the intra-bay conveyance controller 24 on the basis of the scheduler function program of the bay controller 23. Based on the instructions, the equipment controllers 25 control the semiconductor manufacturing equipment 5, and the intra-bay conveyance controller 24 controls the intra-bay conveyance devices 6. Scheduling in the bay controller 23 and the flow shop controller 21 is performed merely by applying the same algorithm in different hierarchical levels. Therefore, for the processes conducted in the inter-bay conveyance device 3, the above-described processing conducted in the intra-bay conveyance devices 6 is set in the same manner by reading the intra-bay conveyance devices 6 as the inter-bay conveyance device 3, and the semiconductor manufacturing equipment 5 as the bays 2.

Scheduling may also be carried out in the semiconductor manufacturing equipment 5 in the same manner as described above. In other words, processes can be carried out in the same manner as above for the scheduler function program in the controller framework of the equipment controller 25 in the semiconductor manufacturing equipment 5. That is to say, the above-described processes carried out in the inter-module conveyance device 8 can be set in the same manner by reading the inter-module conveyance device 8 as the inter-bay conveyance device 3, and the modules 7 as the bays 2.

The same control scheme is thus shared in the scheduler function program in the controller framework. It is therefore convenient to be able to implement the processing content in the same manner by merely changing the equipment name or the like when the equipment is carried over as independent variables, even with processes carried out using different hierarchical levels.

Operating the semiconductor manufacturing system 1 using the scheduler function program set as described above makes it possible to provide a semiconductor manufacturing system 1 in which a shorter TAT (Turn-Around Time) is obtained than by the conventional event-type semiconductor manufacturing system 1.

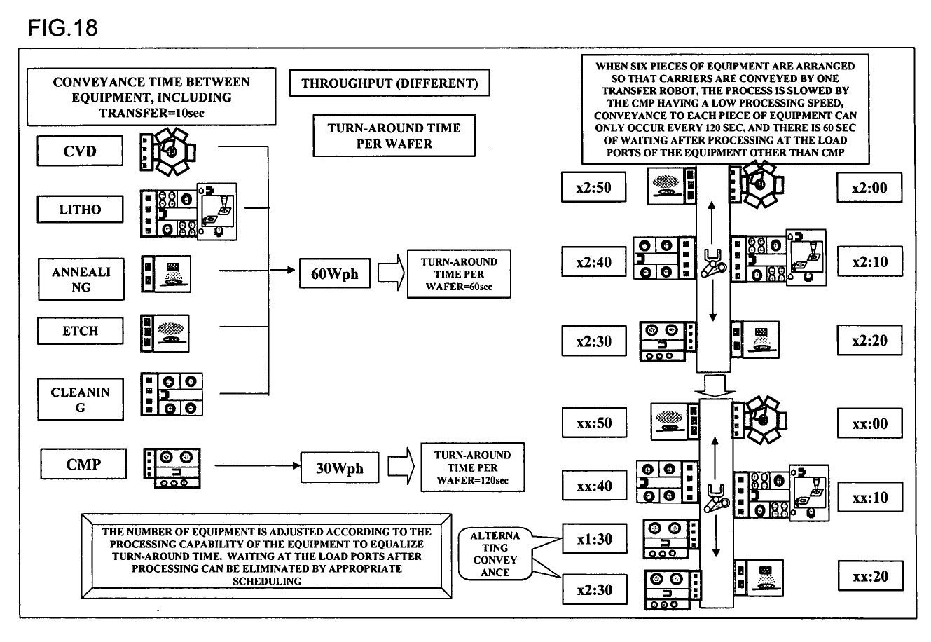

A case was described in which the semiconductor manufacturing equipment 5 have the same throughput in the above-described processing method for determining the number of flow steps, but the throughputs may also be different for each piece of semiconductor manufacturing equipment 5. In this case, a carrier for which processing by semiconductor manufacturing equipment 5 has been completed may be retained at the load port of the semiconductor manufacturing equipment 5. A process for eliminating this type of waiting at the load port will be described hereinafter. The waiting at the load port can be eliminated by using the scheduler function program of the controller framework of flow shop controller 21, the bay controller 23, and the equipment controller 25 to appropriately schedule conveyance in the inter-bay conveyance device 3 and the intra-bay conveyance devices 6. This case is shown schematically in FIG. 18.

In the case shown in FIG. 18, the throughput of the CMP equipment alone is 30 Wph, and the throughput of the other semiconductor manufacturing equipment 5 is 60 Wph. The turn-around time must therefore first be equalized. The equalization of the turn-around times can be determined by the same method as in the above-described procedure for determining the required number of equipment for each piece of semiconductor manufacturing equipment 5. In the example of FIG. 18, the throughput of the CMP equipment alone is one half that of the other equipment, and the turn-around times can therefore be equalized by providing two pieces of CMP equipment. In the same manner, three pieces of semiconductor manufacturing equipment 5 are provided when the throughput thereof is ⅓ that of the other equipment, and four pieces of semiconductor manufacturing equipment are provided when the throughput thereof is ¼ that of the other equipment.

The procedure for eliminating waiting at the load port through scheduling will next be described. First, the intra-bay conveyance devices 6 convey carriers in sequence among a plurality of installed semiconductor manufacturing equipment 5. Since two pieces of CMP equipment are provided in the case of FIG. 18, carriers are conveyed in alternating fashion to the two intra-bay conveyance devices 6. Wait time at the load ports of semiconductor manufacturing equipment 5 for which processing is completed can be eliminated by conveying carriers in alternating fashion to three pieces of equipment when three pieces of equipment are provided, and conveying carriers in alternating fashion to four equipment when four pieces of equipment are provided.

Rescheduling is also performed at a predetermined timing in the scheduling described above, but it is possible for a processed carrier already processed by semiconductor manufacturing equipment 5 to be retained at the load port of semiconductor manufacturing equipment 5 in rescheduling when the turn-around time differs according to recipe. This case of rescheduling will be described.

For example, if conveyance is continued in a case in which the recipe turn-around time in the lithography equipment is as long as 60 to 80 seconds, the wait time between pieces of semiconductor manufacturing equipment may fluctuate, and a carrier may be retained at a load port. One method of eliminating this wait time is described below. When there is a need for zero retention on the load ports of the semiconductor manufacturing equipment 5 in the process for any of the pieces of semiconductor manufacturing equipment 5 to which a carrier is to be conveyed, the carrier processing described hereinafter must be initiated after the preceding carrier has been processed in all the pieces of semiconductor manufacturing equipment 5 of a bay 2. However, it is rare for such a requirement to be made for all the steps in a normal process, and such a requirement is assumed to exist only between certain steps. In this case, when a standby state occurs until the preceding carrier has been processed in all the pieces of the semiconductor manufacturing equipment 5, the total throughput becomes extremely poor.

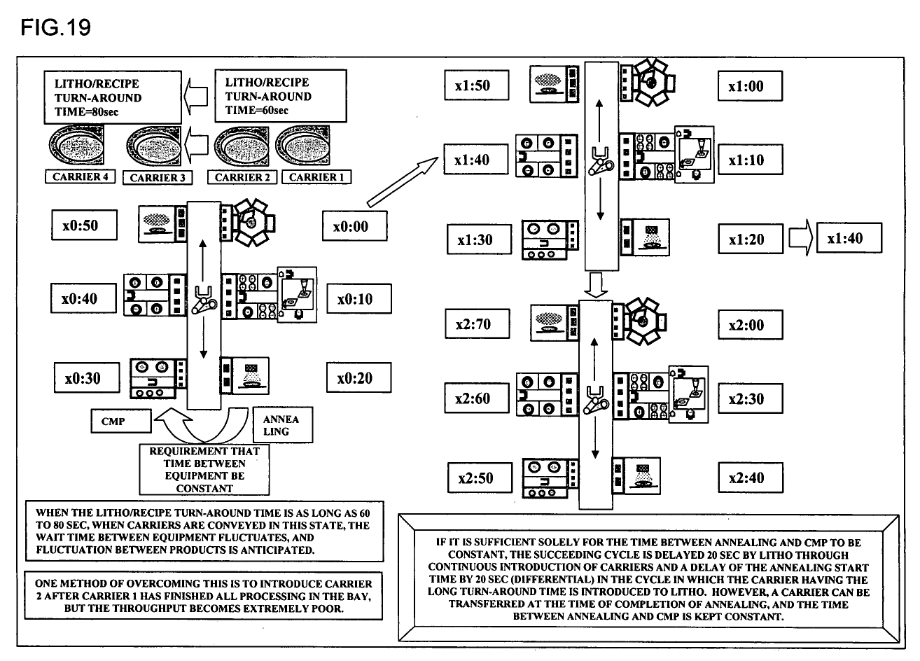

There is therefore a need in the abovementioned case for scheduling by a different method than the one described above. Such a process for eliminating waiting at the load port is described below. This process is shown schematically in FIG. 19.

In such a case, standby states after the completion of processing are eliminated by selecting a schedule in which the time at which the processing of a carrier is started in semiconductor manufacturing equipment 5 is adjusted at the time the preceding carrier is loaded in the semiconductor manufacturing equipment 5 of the corresponding step. For example, in the case shown in FIG. 19, when the turn-around time of the lithography equipment is 20 seconds longer for the carrier 3 that follows the preceding carrier 2, the time between the annealing equipment and the CMP equipment is made constant (i.e., the processing wait time on the load port after completion of processing by the annealing equipment is eliminated).

In this case, in the cycle in which the succeeding carrier having the long turn-around time is loaded into the lithography equipment, a schedule is selected to delay the start of processing by 20 seconds at the time the rapidly processed preceding carrier loaded into the annealing equipment is loaded into the annealing equipment. Although receiving of the carrier by the lithography equipment in the next conveyance cycle is thereby delayed by 20 seconds, the carrier can be unloaded at the time at which processing is completed by the annealing equipment, and waiting at the load port is eliminated as a result.

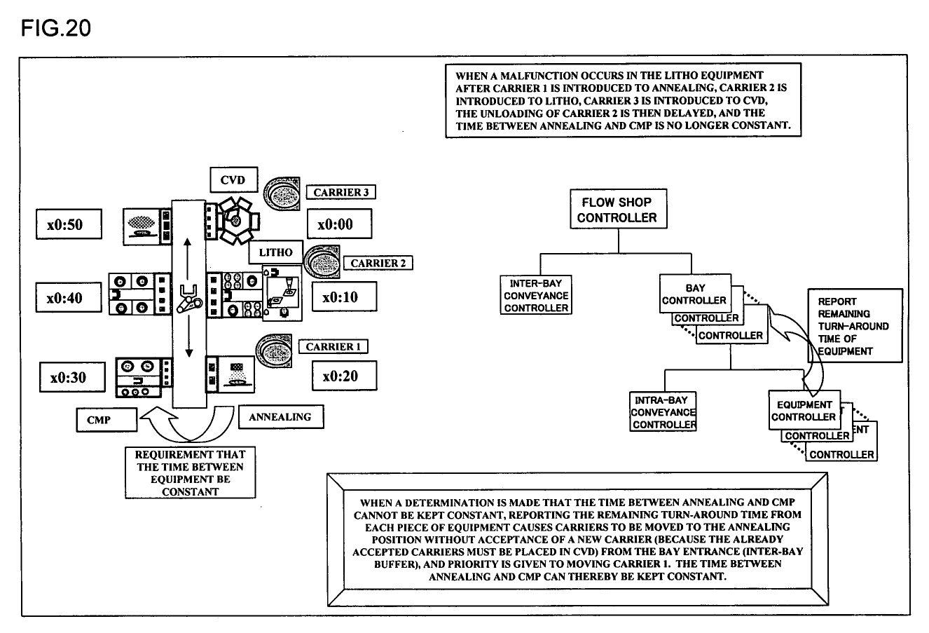

Following is a description of the process for eliminating waiting at the load port in rescheduling when the turn-around time is increased by a malfunction in the semiconductor manufacturing equipment 5. This case is shown schematically in FIG. 20.

In FIG. 20, information relating to the remaining turn-around time for each process is reported via the communication function program to the controller framework in the bay controller 23 from the controller framework in the equipment controller 25 of each piece of semiconductor manufacturing equipment 5. A processing method will be described in which this time information is used to schedule conveyance by the intra-bay conveyance devices 6 using the scheduler function program, whereby the carries are not retained at the load ports even when a malfunction occurs in the semiconductor manufacturing equipment 5.

As described above, information is communicated according to a pre-set specification (e.g., GEM300 defined by the SEMI standard) between the bay controller 23 and the semiconductor manufacturing equipment 5, and a configuration is adopted in which information relating to the remaining turn-around time for each process is also reported to the controller framework of the bay controller 23 from the controller framework in the equipment controller 25 of the semiconductor manufacturing equipment 5 via the communication function program.

The scheduler function program of the bay controller 23 monitors the remaining turn-around time in each piece of semiconductor manufacturing equipment 5, and determines whether the carries will be conveyed on time in semiconductor manufacturing equipment 5 for which no retention at the load port of the semiconductor manufacturing equipment 5 is allowed. When the determination is made that the carries will not be conveyed on time, the bay controller performs a procedure to change the scheduling. In this altered schedule, retention of the carries at the load port is eliminated by performing a procedure to give priority to convey the carries to the semiconductor manufacturing equipment 5 for which retention is not allowed.

However, priority conveyance is not performed when the intra-bay conveyance device 6 is already holding a carrier that is to be conveyed to another piece of semiconductor manufacturing equipment 5 at the time that the scheduler function program of the bay controller 23 determines that conveyance will not be on time. Therefore, when the determination is made that conveyance will not occur by the time the intra-bay conveyance device 6 accesses an inter-bay buffer 4, the intra-bay conveyance device is set so as not to accept a carrier from the inter-bay buffer 4. However, when the carrier is already past the entrance of the bay, the intra-bay conveyance device 6 must temporarily place the carrier in the inter-bay buffer 4. Consequently, this time is also factored into the determination timing. FIG. 20 shows a case in which the time between the annealing equipment and the CMP equipment is made constant even when a malfunction occurs in the lithography equipment.

Configuring the semiconductor manufacturing system 1 as described above makes it possible to provide a semiconductor manufacturing system 1 operating in accordance with a flow shop scheme whereby a shorter processing TAT can be achieved than in the conventional event-type semiconductor manufacturing system 1.

As described above, a controller framework is provided to the controller of each hierarchical level, whereby control of the semiconductor manufacturing system 1 in the wiring step can be shared. In the case that a controller framework is also provided to the MES 20, it is possible to share control in the MES 20, which is the highest level of the factory system, and in the semiconductor manufacturing system 1 according to a flow shop scheme. Accordingly, it is possible to obtain shared control in factory units and to receive data from the semiconductor manufacturing equipment 5 and the like. Therefore, the operating capacities and the like of the semiconductor manufacturing equipment can be managed using a flow shop controller 21 and an MES 20, and a production plan can be produced in accordance with the operating capacity. The result is an increase in productivity overall.

Scheduling and rescheduling are carried out in each controller framework of the flow shop controller 21, the bay controller 23, and the equipment controller 25 on the basis of the detailed equipment data acquired by the EES function program in the controller framework. Productivity can therefore be further improved and a shorter TAT can be achieved.

1. A semiconductor manufacturing system operating in accordance with a flow shop scheme, said semiconductor manufacturing system comprising:
a plurality of bays provided with a plurality of pieces of semiconductor manufacturing equipment and an intra-bay conveyance device for conveying a carrier between said semiconductor manufacturing equipment;
an inter-bay conveyance device for conveying a carrier between said bays; and
a flow shop controller, wherein
each piece of said semiconductor manufacturing equipment has one or more modules comprising a subsystem provided with at least one or more I/O devices;
each of said bays has a bay controller, each piece of said semiconductor manufacturing equipment has an equipment controller, each of said modules has a module controller, each of said subsystems has a subsystem controller, and each of said I/O devices has an I/O controller; and
said flow shop controller, bay controller, equipment controller, module controller, subsystem controller, and I/O controller have a controller framework for implementing each function in accordance with a shared control scheme.

2. The semiconductor manufacturing system according to claim 1, wherein:
the controller framework of each hierarchical control level is provided with at least a communication function program and a time adjustment function program, wherein
the communication function program controls communication with a controller framework of a higher hierarchical control level and/or a lower hierarchical control level; and
the time adjustment function program performs time control for setting the same time or substantially the same time in each controller framework.

3. The semiconductor manufacturing system according to claim 1 or 2, wherein:
the controller framework provided to said equipment controller further has an EES function program, wherein
said EES function program acquires software and hardware event data, as well as analog data and alert data, from the semiconductor manufacturing equipment, and uses the data as detailed equipment data by linking [the data] to a predetermined index; and
said detailed equipment data is transmitted to the controller framework of a higher hierarchical control level via said communication function program.

4. The semiconductor manufacturing system according to claim 3, wherein:
each controller framework provided with said bay controller and said flow shop controller further has an EES function program, wherein
said EES function program transmits the detailed equipment data received from said lower hierarchical control level via said communication function program to the controller framework of a higher hierarchical control level via said communication function program.

5. A semiconductor manufacturing system operating in accordance with a flow shop scheme, said semiconductor manufacturing system comprising:
a plurality of bays provided with a plurality of pieces of semiconductor manufacturing equipment and an intra-bay conveyance device for conveying a carrier between said semiconductor manufacturing equipment;
an inter-bay conveyance device for conveying a carrier between said bays; and
a flow shop controller, wherein
each of said bays has a bay controller, and each piece of said semiconductor manufacturing equipment has an equipment controller;
said flow shop controller, said bay controller, and said equipment controller have a controller framework for implementing each function in accordance with a shared control scheme;
said each controller framework have at least a communication function program and a scheduler function program;
said flow shop controller delivers a control instruction via said communication function program to said bays and said inter-bay conveyance device on the basis of scheduling for said bays and inter-bay conveyance in said scheduler function program;
said bay controller delivers a control instruction via said communication function program to said semiconductor manufacturing equipment and said intra-bay conveyance device on the basis of scheduling for said semiconductor manufacturing equipment and said intra-bay conveyance in said scheduler function program;
said equipment controller delivers a control instruction via said communication function program to said module and said inter-module conveyance device on the basis of scheduling for said module and said inter-module conveyance in said scheduler function program; and
the number of installed equipment and the number of flow steps for each piece of said semiconductor manufacturing equipment are computed on the basis of the operating capacity of lithography equipment as one of said semiconductor manufacturing equipment, and said scheduling is set on the basis of the computed number of installed equipment and the computed number of flow steps.

6. The semiconductor manufacturing system according to claim 5, wherein:
each controller framework in said flow shop controller, said bay controller, and said equipment controller receives, via each communication function program, one or more types of information selected from the group that includes malfunction information, recovery information, and remaining turn-around time information from any one or more piece of said semiconductor manufacturing equipment, said intra-bay conveyance devices, said bays, and said inter-bay conveyance device;
the scheduler function program in said flow shop controller performs rescheduling at a timing at which an entrance of said flow shop is accessed; and
the scheduler function program in said bay controller performs rescheduling at a timing at which an entrance of said bays is accessed.

7. The semiconductor manufacturing system according to claim 6, wherein:
each controller framework further has an EES function program, wherein
said EES function program in said equipment controller acquires software and hardware event data, as well as analog data and alert data, from the semiconductor manufacturing equipment, and uses the data as detailed equipment data by linking [the data] to a predetermined index;
said detailed equipment data is transmitted to the controller framework of a higher hierarchical level via said communication function program;
said EES function program in said bay controller and said flow shop controller transmits the detailed equipment data received from said lower hierarchical level via the communication function program, and
said scheduler function program in each controller framework performs scheduling or rescheduling on the basis of said detailed equipment data.
